(19) United States
(12) Patent Application Publication
(10) Pub. No.: US 2011/0207091 A1
(43) Pub. Date: Aug. 25, 2011

(54) COMPACT MULTI-AIRCRAFT CONFIGURABLE FLIGHT SIMULATOR

(75) Inventor: Paul Dietrich PALMER, JR., Panama City, FL (US)

(73) Assignee: ARINC INCORPORATED, Annapolis, MD (US)

(21) Appl. No.: 12/710,419

(22) Filed: Feb. 23, 2010

(51) Int. Cl. G09B 9/08

(52) U.S. Cl. 434/43

(57) ABSTRACT

A single compact multi-aircraft flight simulator processing unit is disclosed and may include a single chassis, a memory, and a flight simulator control unit housed within the single chassis that operates using a single processor that receives the user's selection of aircraft type, aircraft-type configuration, and start-up parameters to be simulated, retrieves the simulation of the user's selected aircraft type, aircraft-type configuration and start-up parameters from the memory, presents the simulation of the user's selected aircraft type, aircraft-type configuration and start-up parameters to the user, receives a signal from the user to begin the flight simulation experience using the selected aircraft type, aircraft-type configuration and start-up parameters, presents the flight simulation experience to the user, wherein the flight simulation experience displays simulated cockpit window views, displays interactive flight instrument panel views and permits the user to control the flight simulation experience using one or more flight controls.

### BACKGROUND OF THE DISCLOSURE

1. Field of the Disclosure

The disclosure relates to aircraft flight simulators.

2. Introduction

Conventional aircraft flight simulators used by commercial airlines and the military are generally large, complicated and complex configurations and equipment. These simulators require multiple computers, large controls, multiple script file interfaces, and large racks of equipment. In addition, separate simulators are required for each aircraft being modeled. This configuration results in large initial costs in purchasing each simulator, increased space requirements, operation expenses (including cooling the racks of equipment), and maintaining the large amount of equipment required. Moreover, to operate, these simulators require highly skilled technicians that add to the overall cost in both time and resources.

### SUMMARY OF THE DISCLOSURE

A single compact multi-aircraft flight simulator processing unit is disclosed and may include a single chassis, a memory, and a flight simulator control unit housed within the single chassis that operates using a single processor that receives the user's selection of aircraft type, aircraft-type configuration, and start-up parameters to be simulated, retrieves the simulation of the user's selected aircraft type, aircraft-type configuration and start-up parameters from the memory, presents the simulation of the user's selected aircraft type, aircraft-type configuration and start-up parameters to the user, receives a signal from the user to begin the flight simulation experience using the selected aircraft type, aircraft-type configuration and start-up parameters, presents the flight simulation experience to the user, wherein the flight simulation experience displays simulated cockpit window views, displays interactive flight instrument panel views and permits the user to control the flight simulation experience using one or more flight controls, and wherein the start-up parameters include at least one of the simulated location, the airspeed, and altitude of the aircraft.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary diagram of a compact multi-aircraft configurable flight simulator in accordance with a possible embodiment of the disclosure;

FIG. 2 is a block diagram of an exemplary compact multi-aircraft configurable flight simulator processing unit in accordance with a possible embodiment of the disclosure;

FIG. 3 is an exemplary flowchart illustrating one possible compact multi-aircraft configurable flight simulator process in accordance with one possible embodiment of the disclosure;

FIG. 4 is an exemplary screenshot of a possible flight instrument panel display view for the compact multi-aircraft configurable flight simulator in accordance with a possible embodiment of the disclosure; and

FIG. 5 is an exemplary screenshot of one of the possible cockpit view generated by the compact multi-aircraft configurable flight simulator in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed embodiments may concern a low-cost, easy-to-use and easy-to-maintain compact multi-aircraft configurable flight simulator. The compact multi-aircraft configurable flight simulator may be a one computer solution that may be rapidly and easily configured for different aircraft models. The user interface may be menu driven, enabling non-trained operators to easily configure and fly the simulator. The one computer solution may dramatically facilitate the maintainability and availability of the simulator. A remote link may provide for easy upgrade and support.

When changing airplane model, different controls may be plugged in to the compact multi-aircraft configurable flight simulator via a Universal Serial Bus (USB) interface. The compact multi-aircraft configurable flight simulator may integrate multiple cockpit window displays and one or more touch screen instrument displays using just one computer and one processor.

The compact multi-aircraft configurable flight simulator menu may permits easy configuration (e.g., initial conditions, weapons load, fuel, navigation parameters, etc). In this manner, the compact multi-aircraft configurable flight simulator may be fully integrated with flight controls/instrumentation, communications, data link, navigation, and weapons systems. The compact multi-aircraft configurable flight simulator may be a permanent or a portable unit. In this manner, the compact multi-aircraft configurable flight simulator may travel to the location of one or more aviators in need of maintaining or sharpening their skill set (such as a squadron on deployment, for example), as opposed the aviators having to travel to the simulator location which can be inconvenient and costly.

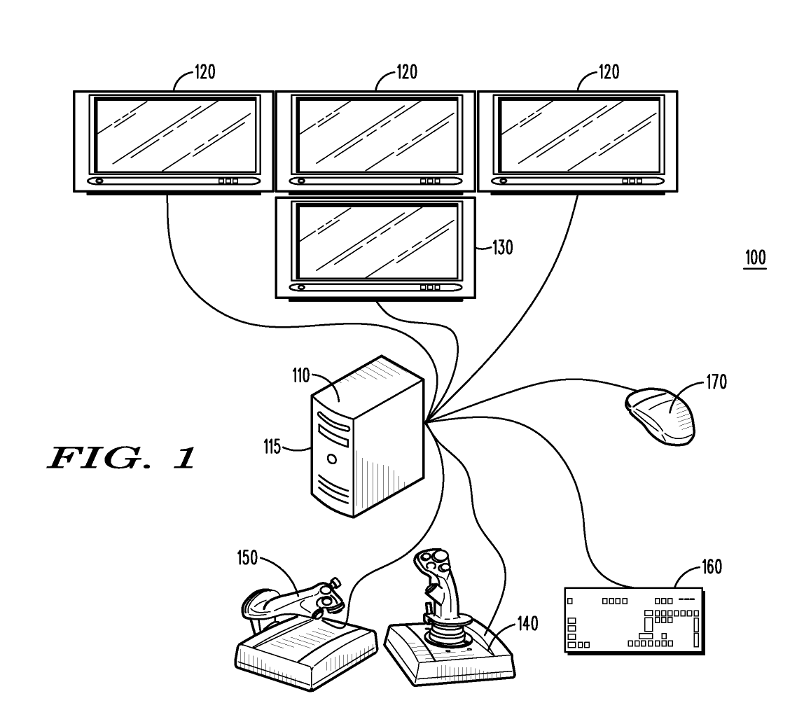

FIG. 1 is an exemplary diagram of a compact multi-aircraft configurable flight simulator 100 in accordance with a possible embodiment of the disclosure. In particular, the compact multi-aircraft configurable flight simulator 100 may includes a compact multi-aircraft flight simulator processing unit 110 (contained within a single chassis 115), one or more cockpit window displays 120, one or more flight instrument displays 130, one or more flight controls 140, 150 (e.g. stick 140 and throttle 150), a keyboard 160, and a mouse 170.

The compact multi-aircraft flight simulator processing unit 110 may be any server, computer, processing device, or other similar device capable of performing a flight simulation experience. The compact multi-aircraft flight simulator processing unit 110 may have a single processor or controller that performs all of the flight simulation functions, for example. In addition, the compact multi-aircraft configurable flight simulator 100 and/or the single compact multi-aircraft configurable flight simulator processing unit 110 may be portable to enable them to be transported to the field, to other airports, to homes, to deployed squadrons, overseas, etc. In this manner, the compact multi-aircraft configurable flight simulator 100 can travel to the aviators instead of the aviators traveling, often thousands of miles, to the simulator.

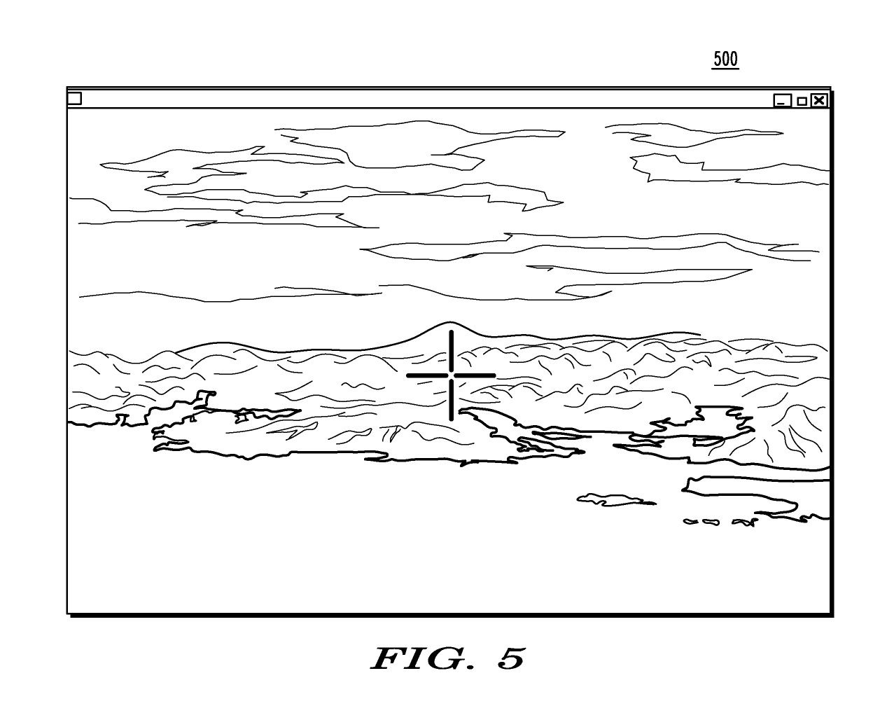

The one or more cockpit window displays 120 may be any type of computer or video display (e.g., CRT, LCD, Plasma, touchscreen, etc.) that may connect to the compact multi-aircraft flight simulator processing unit 110 via any type of known or future-developed connector (e.g., USB, serial, HDMI, etc.). The one or more cockpit window displays 120 may display a simulation of what a pilot may see while looking out a cockpit window. If two or more of the one or more cockpit window displays 120 are used, the simulated overall cockpit view may be stitched together so that each window may display a portion of the overall cockpit view as a pilot would see it out of his or her window during a flight. As an example, FIG. 5 is an exemplary screenshot of one of the possible cockpit view 500 generated by the compact multi-aircraft configurable flight simulator 100 in accordance with a possible embodiment of the disclosure.

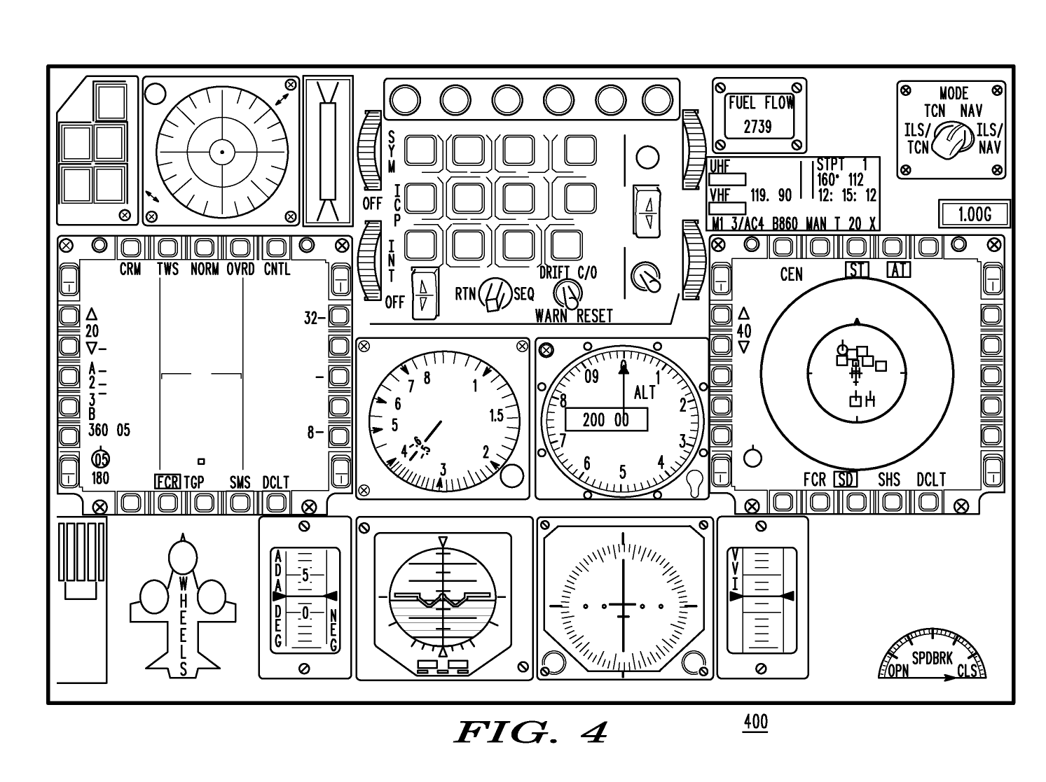

The one or more flight instrument panel displays 130 may be any type of computer or video display (e.g., CRT, LCD, Plasma, touchscreen, etc.) that may connect to the compact multi-aircraft flight simulator processing unit 110 via any type of known or future-developed connector (e.g., USB, serial, HDMI, etc.). In a preferred embodiment, the one or more flight instrument panel displays 130 may be a touchscreen display to allow the pilot to simulate touching the displayed instruments and dials. The instruments and dials may include an airspeed indicator, an altimeter, an attitude indicator, fuel gauges, warning lights, radar, landing gear indicator, weapons controls/indicators, communications equipment and indicators, instrument approach indicators, navigation aids, and other cockpit instruments and indicators that may vary by aircraft type and configuration. As an example, FIG. 4 is an exemplary screenshot of a possible flight instrument panel display view 400 for the compact multi-aircraft configurable flight simulator in accordance with a possible embodiment of the disclosure.

The one or more flight controls 140, 150 may represent and type of flight controls for any type or configuration of any commercial or military aircraft. For example, the flight controls may be stick 140 (a lever used to control the motion of an aircraft by changing the angle of the elevators and ailerons), a throttle 150 (a lever that controls how much fuel is delivered to the engine and hence, controls the speed of the aircraft), rudder controls, brakes, weapons controls, communications controls, etc. The flight controls 140, 150 may connect to the compact multi-aircraft flight simulator processing unit 110 via any type of known or future-developed connector (e.g., USB, serial, HDMI, wireless, etc.).

The keyboard 160 and the mouse 170 may connect to the compact multi-aircraft flight simulator processing unit 110 via any type of known or future-developed connector (e.g., USB, serial, HDMI, wireless, etc.). The keyboard 160 and the mouse 170 may be used to control other aspects of the compact multi-aircraft configurable flight simulator 100. For example, the keyboard 160 and/or the mouse 170 may provide inputs to the compact multi-aircraft flight simulator processing unit 110 in place of or in conjunction with the flight controls 140, 150. The keyboard 160 and/or the mouse 170 may also provide inputs to the compact multi-aircraft flight simulator processing unit 110 for loading, set-up, configuration, etc. of a flight simulation experience, for example. The compact multi-aircraft configurable flight simulator 100 may also receive inputs from other devices, computers, servers, other flight simulators, etc. through a communications network via the compact multi-aircraft flight simulator processing unit 110, for example. The communications network a may represent any possible communications network that may handle VoIP telephonic communications, including wireless telephone networks, hardwired telephone networks, wireless local area networks (WLAN), the Internet, an intranet, etc., for example. The compact multi-aircraft configurable flight simulator 100 through the compact multi-aircraft flight simulator processing unit 110 may receive audio communications simulating at least one of an Air Traffic Controller, a Ground Controller, and another aircraft, for example.

The compact multi-aircraft configurable flight simulator 100 may also allow coordination of more than one flight simulation experience, such as for coordinated squadron operations, formation flying, in-air refueling, etc. As such, the compact multi-aircraft configurable flight simulator 100 and its single compact multi-aircraft flight simulator processing unit 110 may be linked with one or more other single compact multi-aircraft flight simulator processing units each performing a separate flight simulation experience so that one of a coordinated flight and a formulation flight may me simulated.

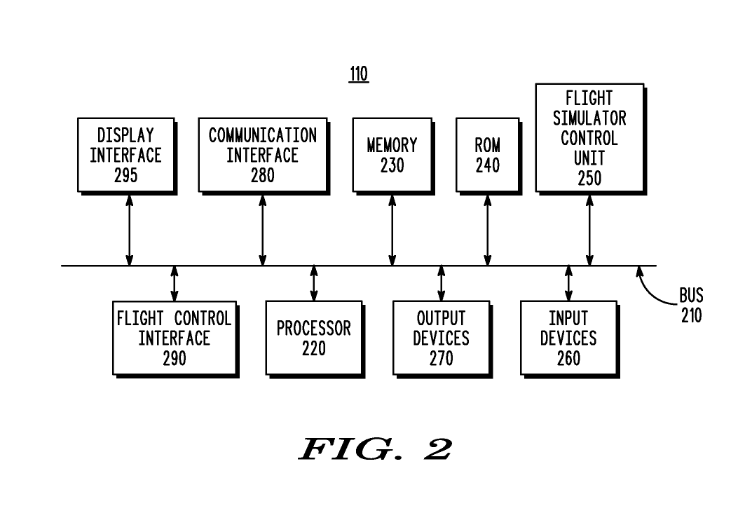

FIG. 2 is a block diagram of an exemplary compact multi-aircraft configurable flight simulator processing unit 110 in accordance with a possible embodiment of the disclosure. The exemplary compact multi-aircraft configurable flight simulator processing unit 110 may include a bus 210, a processor 220, a memory 230, a read only memory (ROM) 240, a flight simulator control unit 250, input devices 260, output devices 270, a communication interface 280, a flight control interface 290, and a display interface 295. Bus 210 may permit communication among the components of the compact multi-aircraft configurable flight simulator processing unit 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any type of storage media or media drive, such as, for example, magnetic or optical recording media and its corresponding drive.

Input device 260 may include one or more conventional mechanisms that may permit a user to input information to the compact multi-aircraft flight simulator processing unit 110, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the compact multi-aircraft configurable flight simulator processing unit 110 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections.

Display interface 295 may be any interface known to one of skill in the art that permits the compact multi-aircraft configurable flight simulator processing unit 110 to communicate with the displays 120, 130 so that the desired simulated cockpit or instrument panel view will be displayed, for example. Flight control interface 290 may be any interface known to one of skill in the art that permits the compact multi-aircraft configurable flight simulator processing unit 110 to communicate with the flight controls 140, 150 and/or the keyboard/mouse when they are used to communicate flight control signals, for example.

The compact multi-aircraft configurable flight simulator processing unit 110 may perform such functions in response to processor 220 by executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

The compact multi-aircraft flight simulator 100 and the compact multi-aircraft configurable flight simulator processing unit 110 illustrated in FIGS. 1 and 2 and the related discussion are intended to provide a brief, general description of a suitable computing environment in which the disclosure may be implemented. Although not required, the disclosure will be described, at least in part, in the general context of computer-executable instructions, such as program modules, being executed by the compact multi-aircraft configurable flight simulator processing unit 110, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

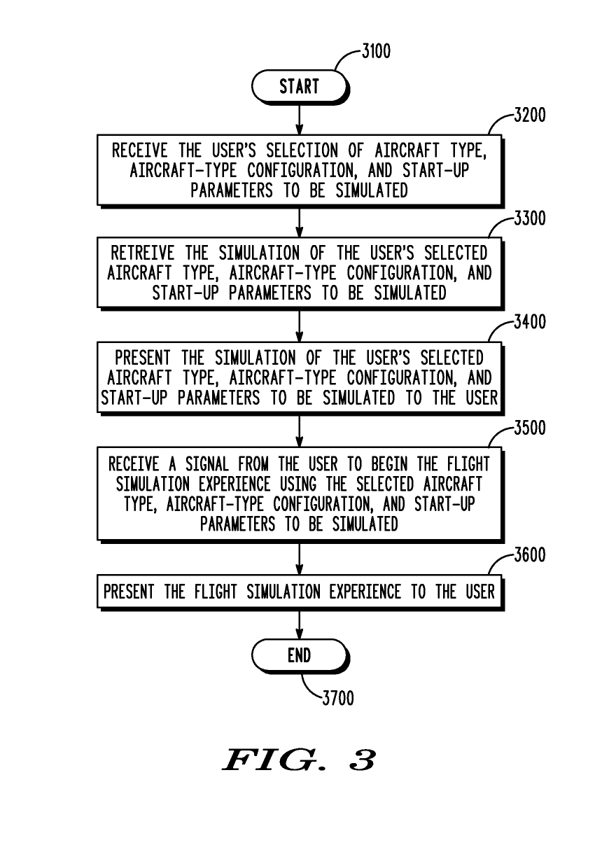

For illustrative purposes, the operation of the flight simulator control unit 250 and the compact multi-aircraft configurable flight simulator process will be described below in FIG. 3 in relation to the block diagrams shown in FIGS. 1-2.

FIG. 3 is an exemplary flowchart illustrating some of the basic steps associated with the compact multi-aircraft configurable flight simulator process in accordance with a possible embodiment of the disclosure. The process begins at step 3100 and continues to step 3200 where the flight simulator control unit 250 may operate using a single processor and may receive the user's selection of aircraft type, aircraft-type configuration, and start-up parameters to be simulated. In this manner, the flight simulator control unit 250 may prompt the user to select a particular aircraft, a particular configuration, and particular start-up parameters from a plurality of military, commercial, or private aircraft and aircraft configurations. The start-up parameters may include the simulated location, the airspeed, the altitude, weapons load, etc. of the aircraft, for example.

At step 3300, the flight simulator control unit 250 may retrieve the simulation of the user's selected aircraft type and aircraft-type configuration from the memory 230 or may download the user's selected aircraft type, aircraft-type configuration, and start-up parameters from another source, such as a CD, DVD, flash memory drive, the Internet, external hard drive, etc. At step 3400, the flight simulator control unit 250 may present the simulation of the user's selected aircraft type, aircraft-type configuration, and start-up parameters to the user.

At step 3500, the flight simulator control unit 250 may receive a signal from the user to begin the flight simulation experience using the selected aircraft type, aircraft-type configuration, and start-up parameters. At step 3600, the flight simulator control unit 250 may present the flight simulation experience to the user. The flight simulation experience may display simulated cockpit window views, may display interactive flight instrument panel views and may permit the user to control the flight simulation experience using one or more flight controls. The process may then go to step 3700 and end.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the component described in the disclosed embodiments each processing the content in various possible ways. It does not necessarily need to be one system used by all end users. Accordingly, the appended claims and their legal equivalents should only define the disclosure, rather than any specific examples given.

We claim:

1. A compact multi-aircraft configurable flight simulator, comprising:
one or more flight controls that respond to a user's input and control at least one of the movement of a simulated aircraft, weapons deployment, and communications;
one or more cockpit window displays that display the simulated external view from a cockpit of the simulated aircraft;
one or more instrument panel displays that display one or more simulated flight instruments from the cockpit of the simulated aircraft; and
a single compact multi-aircraft flight simulator processing unit having a single chassis, a single processor and a memory housed within the single chassis, that receives the user's selection of aircraft type, aircraft-type configuration to be simulated, and start-up parameters, retrieves the simulation of the user's selected aircraft type, aircraft-type configuration, and start-up parameters from the memory, presents the simulation of the user's selected aircraft type, aircraft-type configuration, and start-up parameters to the user, receives a signal from the user to begin the flight simulation experience using the selected aircraft type, aircraft-type configuration, and start-up parameters, presents the flight simulation experience to the user,
wherein the flight simulation experience displays simulated cockpit window views, displays interactive flight instrument panel views and permits the user to control the flight simulation experience using one or more flight controls, and
wherein the start-up parameters include at least one of the simulated location, the airspeed, and altitude of the aircraft.

2. The compact multi-aircraft configurable flight simulator of claim 1, wherein single compact multi-aircraft flight simulator processing unit receives audio communications simulating at least one of an Air Traffic Controller, a Ground Controller, and another aircraft.

3. The compact multi-aircraft configurable flight simulator of claim 1, wherein the aircraft type and configuration to be simulated is one of a commercial aircraft and a military aircraft.

4. The compact multi-aircraft configurable flight simulator of claim 1, wherein the single compact multi-aircraft flight simulator processing unit may be linked with one or more other single compact multi-aircraft flight simulator processing units each performing a separate flight simulation experience so that one of a coordinated flight and a formulation flight may me simulated.

5. The compact multi-aircraft configurable flight simulator of claim 1, wherein the displays and the flight controls are connected to the single compact multi-aircraft flight simulator processing unit using one of Universal Serial Bus (USB) cable, wireless connection, serial cable, and High Definition Multimedia Interface (HDMI) cable.

6. The compact multi-aircraft configurable flight simulator of claim 1, wherein the compact multi-aircraft configurable flight simulator is portable.

7. The compact multi-aircraft configurable flight simulator of claim 1, wherein the compact multi-aircraft flight simulator processing unit is one of a server, a computer, and a processing device.

8. A single compact multi-aircraft flight simulator processing unit, comprising:
a single chassis;
a memory; and
a flight simulator control unit housed within the single chassis that operates using a single processor that receives the user's selection of aircraft type, aircraft-type configuration, and start-up parameters to be simulated, retrieves the simulation of the user's selected aircraft type, aircraft-type configuration, and start-up parameters from the memory, presents the simulation of the user's selected aircraft type, aircraft-type configuration, and start-up parameters to the user, receives a signal from the user to begin the flight simulation experience using the selected aircraft type, aircraft-type configuration, and start-up parameters, presents the flight simulation experience to the user,
wherein the flight simulation experience displays simulated cockpit window views, displays interactive flight instrument panel views and permits the user to control the flight simulation experience using one or more flight controls, and
wherein the start-up parameters include at least one of the simulated location, the airspeed, and altitude of the aircraft.

9. The single compact multi-aircraft flight simulator processing unit of claim 8, wherein the flight simulator control unit receives audio communications simulating at least one of an Air Traffic Controller, a Ground Controller, and another aircraft.

10. The single compact multi-aircraft flight simulator processing unit of claim 8, wherein the aircraft type and configuration to be simulated is one of a commercial aircraft and a military aircraft.

11. The single compact multi-aircraft flight simulator processing unit of claim 8, wherein the single compact multi-aircraft flight simulator processing unit may be linked with one or more other single compact multi-aircraft flight simulator processing units each performing a separate flight simulation experience so that one of a coordinated flight and a formulation flight may me simulated.

12. The single compact multi-aircraft flight simulator processing unit of claim 8, wherein the displays and the flight controls are connected to the single compact multi-aircraft flight simulator processing unit using one of Universal Serial Bus (USB) cable, wireless connection, serial cable, and High Definition Multimedia Interface (HDMI) cable.

13. The single compact multi-aircraft flight simulator processing unit of claim 8, wherein the single compact multi-aircraft configurable flight simulator processing unit is portable.

14. The single compact multi-aircraft flight simulator processing unit of claim 8, wherein the compact multi-aircraft flight simulator processing unit is one of a server, a computer, and a processing device.

15. A method for providing a flight simulation experience using a single compact multi-aircraft flight simulator processing unit, comprising:
receiving the user's selection of aircraft type, aircraft-type configuration, and start-up parameters to be simulated;
retrieving the simulation of the user's selected aircraft type, aircraft-type configuration, and start-up parameters;
presenting the simulation of the user's selected aircraft type, aircraft-type configuration, and start-up parameters to the user;
receiving a signal from the user to begin the flight simulation experience using the selected aircraft type, aircraft-type configuration, and start-up parameters;
presenting the flight simulation experience to the user, wherein the flight simulation experience displays simulated cockpit window views, displays interactive flight instrument panel views and permits the user to control the flight simulation experience using one or more flight controls,
wherein the single compact multi-aircraft flight simulator processing unit is contained in a single chassis and uses a single processor to perform the method, and
wherein the start-up parameters include at least one of the simulated location, the airspeed, and altitude of the aircraft.

16. The method of claim 15, further comprising:
receiving audio communications simulating at least one of an Air Traffic Controller, a Ground Controller, and another aircraft.

17. The method of claim 15, wherein the aircraft type and configuration to be simulated is one of a commercial aircraft and a military aircraft.

18. The method of claim 15, wherein the single compact multi-aircraft flight simulator processing unit may be linked with one or more other single compact multi-aircraft flight simulator processing units each performing a separate flight simulation experience so that one of a coordinated flight and a formulation flight may me simulated.

19. The method of claim 15, wherein the displays and the flight controls are connected to the single compact multi-aircraft flight simulator processing unit using one of Universal Serial Bus (USB) cable, wireless connection, serial cable, and High Definition Multimedia Interface (HDMI) cable.

20. The method of claim 15, wherein the single compact multi-aircraft configurable flight simulator processing unit is portable.

21. The method of claim 15, wherein the single compact multi-aircraft flight simulator processing unit is one of a server, a computer, and a processing device.
